(19) United States
(12) Patent Application Publication
(10) Pub. No.: US 2019/0172411 A1
(43) Pub. Date: Jun. 6, 2019

(54) VISUAL DISPLAY SYSTEM AND METHOD

(71) Applicant: Ford Global Technologies, LLC, Dearborn, MI (US)

(72) Inventors: Andrew Murray, Colchester (GB); James Neugebauer, Chelmsford (GB); Richard Craven, Chelmsford (GB)

(73) Assignee: Ford Global Technologies, LLC, Dearborn, MI (US)

(21) Appl. No.: 16/206,914

(22) Filed: Nov. 30, 2018

(30) Foreign Application Priority Data
Dec. 1, 2017 (GB) 1720039.5

(51) Int. Cl. G09G 5/00; B60K 35/00; H04W 4/021

(52) U.S. Cl. CPC G09G 5/003; B60K 35/00; H04W 4/021; B60K 2350/106; G09G 2380/10; B60K 2350/352; B60K 2350/355; G09G 2330/02

(57) ABSTRACT

A visual display system for a vehicle is provided. The visual display system comprises an electronic display visible from the exterior of the vehicle, wherein the electronic display is configurable to have the appearance of the vehicle bodywork, for example when it is not in use to display a message sign or image. A method of controlling a visual display on a vehicle is also provided.

### CROSS-REFERENCE TO RELATED APPLICATIONS

The present disclosure claims priority to and the benefit of GB application No. 1720039.5, filed Dec. 1, 2017, which is hereby incorporated by reference herein in its entirety.

### TECHNICAL FIELD

The present disclosure relates to a visual display system for a vehicle and is particularly, although not exclusively, concerned with a visual display system configured to improve the functionality of vehicle signage.

### BACKGROUND

When commercial vehicles such as vans are used by multiple operators (e.g. rental use, shared ownership) or to serve multiple clients/consignors (e.g. Uber RUSH, lifestyle couriers) traditional ‘permanent’ livery or signage on the exterior of the vehicle may be impractical or undesirable.

It is desirable to provide a visual display system with improved functionality of vehicle signage.

### STATEMENTS OF INVENTION

According to an aspect of the present disclosure, there is provided a visual display system for a vehicle, the system comprising an electronic display visible from the exterior of the vehicle, wherein the electronic display is configurable to have the appearance of the vehicle bodywork.

According to another aspect of the present disclosure, there is provided a visual display system for a vehicle, the visual display system comprising: an electronic display which is visible from outside the vehicle, and a controller for controlling an image displayed on the electronic display, wherein the controller is configured to control the image displayed on the electronic display based on a time of day and/or an ambient light level.

The electronic display may be visible from outside the vehicle for example by being located on an exterior portion of the vehicle or being located inside a vehicle and be visible on or through a window of a vehicle. For example the image on the display may be projected onto a window of the vehicle.

A time of day may be any one of daylight hours, specific hours of the day, working hours, etc.

Ambient light levels may be used to ensure an electronic display is lit up when the ambient light is not sufficient for the image displayed on the electronic display to be easily seen by a viewer. Alternatively, ambient light levels may be used to set a brightness of the image displayed on the electronic display, so that during darkness (times of lower ambient light) viewers are not dazzled by the image displayed on the electronic display.

The controller may comprises a time monitor capable of monitoring the time of day. The controller may be configured to activate or deactivate the electronic display based on a determination of whether the time of day matches a predetermined time of day. The predetermined time of day may be a period of several hours during which the electronic display is activated or deactivated, or may be a specific time at which the electronic display is to be activated or deactivated, which may be followed by a later specific time at which the electronic display is to be deactivated or activated, respectively.

The controller may further comprise an optical sensor capable of detecting ambient light levels. The controller may be configured to activate or deactivate the electronic display based on a determination of whether the detected level of ambient light matches a predetermined level of ambient light. The predetermined light level may be a specific threshold or a range over which the electronic display may be either activated or deactivated.

The controller may be further configured to control the image displayed on the electronic display or to activate or deactivate the electronic display based on an input (for example data) received from a user input device. The user input device may be a mobile device. The mobile device may be capable of performing wireless communication with the controller.

The system may further comprise a vehicle locator. The controller may be further configured to activate or deactivate the electronic display based on a determination whether the location of the vehicle matches a predetermined location. The predetermined location may be set according to a geo-fence. The controller may control the image displayed on the electronic display based on the location of the vehicle (whether the location of the vehicle matches the predetermined location) and may activate or deactivate the display at certain locations or within certain areas. For example, the electronic display may be deactivated when the location of the vehicle matches a “home” location, such as where the vehicle is parked overnight or when not in use. As a further example, the display may be activated or the image displayed changed when the vehicle arrives at a pick-up location, so that the vehicle may be readily identified.

A geo-fence may be positioned at or around a specified area. A geo-fence may be a geographical barrier or threshold which is detectable by the controller, and, when the geo-fence is passed, the controller may control the image displayed on the at least one electronic display, for example to change the image. The threshold may be detectable by a separate detector in communication with the controller.

The electronic display may comprise a liquid crystal display (LCD) screen, light-emitting diode (LED) screen or a plasma technology screen. The electronic display may comprise e-ink or e-paper display technology. The system may comprise one or more backlit electronic displays (liquid crystal display (LCD) screen, light-emitting diode (LED) screen or plasma technology screen) and one or more non-backlit screens (e-ink or e-paper display) and may control which electronic display is activated (or deactivated) according to the time of day and/or the ambient light level. For example, during the day time a non-backlit electronic display may be activated as the ambient light is sufficient that the image displayed can be seen by a viewer. During the night time, the non-backlit electronic display may be deactivated and the backlit electronic display activated, so that the image is still visible in the lower ambient light. Alternatively, the non-backlit electronic display may be activated and the backlit electronic display deactivated during the night time, so that the image is still displayed, but energy may be saved by using a non-backlit electronic display.

The electronic display may be integrated within exterior bodywork of the vehicle. When deactivated or not in use to display a message, sign or image, the electronic display may be configured to have the appearance of the vehicle bodywork, such that it is not readily identifiable that an electronic display is present. For example, where the vehicle bodywork is painted white, the display may be configured to show a plain white image when it is deactivated or not in use to display a message, sign or image. In this way, the electronic display merges into the vehicle body work. This may prevent vandalism or theft from the vehicle when it is unattended.

The system may further comprise a power source that is independent from a main power source of the vehicle, such as the vehicle battery which powers other vehicle systems. Using a separate power source allows the electronic display to operate without draining the main vehicle battery or using additional road fuel to recharge the vehicle battery.

According to another aspect of the present disclosure, there is provided a vehicle comprising the system as described above.

According to another aspect of the present disclosure, there is provided a method of controlling a visual display on a vehicle, the method comprising:
providing an electronic display visible from an exterior of the vehicle, and
configuring the electronic display to have the appearance of the vehicle bodywork.

According to another aspect of the present disclosure, there is provided a method of controlling a visual display on a vehicle, the method comprising: providing an electronic display on an exterior portion of the vehicle, providing means for controlling an image displayed on the electronic display, and controlling the image that is displayed on the electronic display based on a time of day and/or an ambient light level.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a block diagram of a visual display system according to an arrangement; and

FIG. 2 shows a block diagram of a visual display system according to another arrangement.

### DETAILED DESCRIPTION

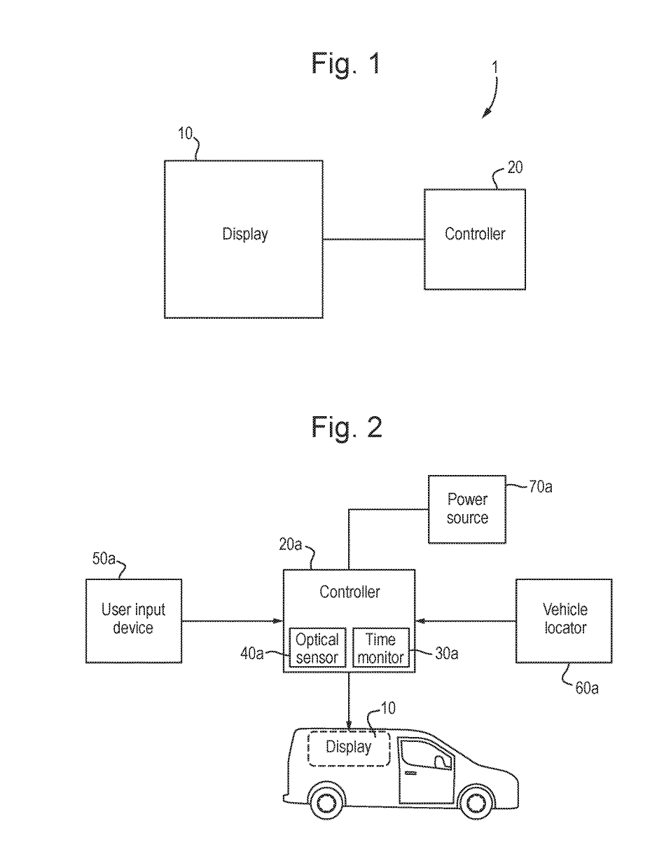

With reference to FIG. 1, a visual display system 1 for a motor vehicle comprises an electronic display (display) 10 and a controller 20. In the arrangement depicted in FIG. 1, the controller 20 is configured to control an image displayed on the electronic display 10. The visual display system 1 may, according to an arrangement, be fitted to a vehicle, such as a commercial vehicle, a van or similar. The electronic display 10 may be located on an exterior portion of the vehicle. For example, the electronic display 10 may be attached to or integrated with the sides or the rear of the vehicle to enable logos, graphics and/or text to be displayed.

In the arrangement, according to FIG. 1, the visual display system 1 comprises one electronic display 10. However, the visual display system 1 may comprise two or more electronic displays 10. For example, a vehicle may include one electronic display 10 on either side of the vehicle and one on the rear of the vehicle. The exterior portion of the vehicle to which the electronic display 10 is attached may be any outward facing surface of the vehicle such that an image displayed on the electronic display 10 may be seen by members of the public who are outside or near the vehicle. The controller 20 may be any suitable controller operable to control one or more electronic displays 10.

With reference to FIG. 2, in an arrangement, there is provided a display (electronic display) 10, a controller 20a, a user input device 50a, such as a control console, smart phone or tablet, a vehicle locator 60a and a power source 70a. The controller 20a may comprise a time monitor 30a and an optical sensor 40a. It is to be understood that insofar as it is technically possible one or more of these features may be combined with the features of other embodiments together with or in isolation from the others shown in this arrangement.

As shown in FIG. 2, a display 10 may be located on the side of a commercial vehicle, in this case a van. The controller 20a may control the image displayed on the display 10. The controller 20a may control the image displayed on the display 10 based on a time of day and/or an ambient light level. For example, a vehicle may have set hours during which it is in use. The controller 20a may be configured to activate the display 10 during these hours and deactivate the display 10 at the end of the time during which the vehicle is in use. Alternatively, it may be desirable for the vehicle to display an image regardless of vehicle use. In an arrangement therefore, the controller 20a may activate the display 10 during specific hours of the day. For example, the controller 20a may activate the display 10 during the hours of 06:00-20:00 so that an image is displayed during this time. The controller 20a may, in combination with or independently of the above control, control the display 10 to activate or deactivate based on ambient light levels. It may be desirable for the display 10 to display an image either during the day or during the night only. Therefore, the controller may for example activate the display 10 when ambient light either reaches a sufficient level (which may indicate dawn) or drops to a sufficiently low level (which may indicate dusk). Ambient light levels may be used to ensure that the display 10 is lit up when the ambient light is not sufficient for the image displayed on the display 10 to be easily seen by a viewer. Alternatively, ambient light levels may be used to set a brightness of the image displayed on the display 10, so that during darkness (times of lower ambient light) viewers are not dazzled by the image displayed on the display 10.

With reference to the arrangement shown in FIG. 2 the controller 20a may further comprise a time monitor (timer or clock) 30a. The time monitor 30a may be capable of monitoring the time of day. The controller 20a may be configured to activate or deactivate the display 10 based on the time monitored by the time monitor 30a. The controller 20a may activate or deactivate the display 10 based on a determination whether the time of day matches a predetermined time of day. A predetermined time of day may be a specific point in time or may be a period over which the controller 20a performs control.

With reference to the arrangement shown in FIG. 2 the controller 20a may further comprise an optical sensor 40a. The optical sensor 40a may be capable of detecting ambient light levels. The optical sensor 40a may for example be a lux meter for the detection of lumen (or lumen per square meter). The controller 20a may be configured to activate or deactivate the display 10 based on the ambient light level detected by the optical sensor 40a. The controller 20a may activate or deactivate the display 10 based on whether the ambient light level matches a predetermined level of ambient light. The predetermined light level may be a specific threshold (a maximum or minimum, for example) or a range over which the display 10 may be either activated or deactivated.

The vehicle locator 60a may be a GPS (Global Positioning System) or similar and may be capable of locating the vehicle on any suitable mapping or coordinate system. The controller 20a may activate or deactivate the display 10 based on the location of the vehicle determined by the vehicle locator 60a. The controller 20a may activate or deactivate the display 10 based on a determination whether the location of the vehicle matches a predetermined location. The predetermined location may be a single point or may be an area. The predetermined location may be set according to a geo-fence. A geo-fence may be extended around an area to indicate to the controller 20a to activate or deactivate the display 10.

A geo-fence may be any suitable form of geographic boundary, representative boundary or virtual boundary and may be set for example based on user input or an anticipated route of the vehicle. The geo-fence may set a particular territory or area, wherein when the vehicle is located within the area the display 10 may be activated and display an image associated with that area. For example, the vehicle may display an advertisement relevant to a local area, but when travelling outside that area may display an alternative image or may be deactivated.

In an arrangement, the display control module 20a is configured to additionally control the image displayed on the display 10 based on input received from the user input device 50a. For example, a driver of a vehicle may determine that the image displayed, while in an appropriate area, may no longer be suitable and therefore may wish to control the display 10 to display an alternative image or to deactivate the display 10. The user input device 50a may be a mobile device capable of wireless communication with the controller 20a. For example, the mobile device may be located in the vehicle such that a user may activate or deactivate the display 10 from inside the vehicle. The user input device 50a may for example comprise a mobile phone or other hand held smart device.

In an arrangement, the display 10 may comprise a liquid crystal display (LCD) screen, a light emitting diode (LED) screen or a plasma technology screen. In an arrangement, the display 10 may comprises an e-ink or e-paper technology display. An e-ink or e-paper display may for example not use its own backlight when displaying an image and instead may use reflection of the ambient light from the surrounding environment.

In an arrangement, a vehicle may include multiple displays 10, wherein these multiple displays include at least one display such as an LED screen and another display such as an e-ink or e-paper display. In this arrangement it may be possible to reduce the energy consumption of the vehicle by switching to the e-ink or e-paper display at times of higher ambient light where backlit displays are not required. A further benefit would be to use the e-ink or e-paper display when local legislation prohibits certain forms of light emission from moving vehicles.

Additional statements of invention are set out below.

Statement 1. A visual display system for a vehicle, the system comprising:
an electronic display visible from the exterior of the vehicle, wherein the electronic display is configurable to have the appearance of the vehicle bodywork.

Statement 2. A visual display system according to statement 1, further comprising a controller which is configured to control the image displayed on the electronic display based on at least one of a time of day and an ambient light level.

Statement 3. A visual display system according to statement 2, wherein the controller comprises a time monitor capable of monitoring the time of day, wherein the controller is configured to activate or deactivate the electronic display based on a determination whether the time of day matches a predetermined time of day.

Statement 4. A visual display system according to statement 2 or 3, wherein the controller comprises an optical sensor capable of detecting ambient light levels, wherein the controller is configured to activate or deactivate the electronic display based on a determination whether the detected level of ambient light matches a predetermined level of ambient light.

Statement 5. A visual display system according to any preceding statement, wherein the electronic display is configurable to activate or deactivate the electronic display based on data received from a user input device.

Statement 6. A visual display system according to any preceding statement, wherein the system further comprises a vehicle locator and the controller is further configured to activate or deactivate the electronic display based on a determination of whether the location of the vehicle matches a predetermined location.

Statement 7. A visual display system according to statement 6, wherein the predetermined location is set according to a geo-fence.

Statement 8. A visual display system according to any preceding statement, wherein the electronic display comprises a liquid crystal display (LCD) screen, light-emitting diode (LED) screen or a plasma technology screen.

Statement 9. A visual display system according to any preceding statement, wherein the electronic display comprises e-ink or e-paper display technology.

Statement 10. A visual display system according to any preceding statement, wherein the electronic display is integrated within exterior bodywork of the vehicle.

Statement 11. A visual display system according to any preceding statement, wherein the system further comprises a power source that is independent from a main electrical power source of the vehicle.

Statement 12. A visual display system according to statement 5, wherein the user input device is a mobile device.

Statement 13. A visual display system according to statement 12, wherein the user input device is a smart phone or tablet.

Statement 14. A vehicle comprising the system according to any preceding statement.

Statement 15. A method of controlling a visual display on a vehicle, the method comprising:
providing an electronic display visible from an exterior of the vehicle, and
configuring the electronic display to have the appearance of the vehicle bodywork.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

We/I claim:

1. A visual display system for a vehicle, the system comprising:
an electronic display visible from the exterior of the vehicle, wherein the electronic display is configurable to have the appearance of the vehicle bodywork.

2. A visual display system according to claim 1, further comprising a controller which is configured to control the image displayed on the electronic display based on at least one of a time of day and an ambient light level.

3. A visual display system according to claim 2, wherein the controller comprises a time monitor capable of monitoring the time of day, wherein the controller is configured to activate or deactivate the electronic display based on a determination whether the time of day matches a predetermined time of day.

4. A visual display system according to claim 2, wherein the controller comprises an optical sensor capable of detecting ambient light levels, wherein the controller is configured to activate or deactivate the electronic display based on a determination whether the detected level of ambient light matches a predetermined level of ambient light.

5. A visual display system according to claim 1, wherein the electronic display is configurable to activate or deactivate the electronic display based on data received from a user input device.

6. A visual display system according to claim 1, wherein the system further comprises a vehicle locator and the controller is further configured to activate or deactivate the electronic display based on a determination of whether the location of the vehicle matches a predetermined location.

7. A visual display system according to claim 6, wherein the predetermined location is set according to a geo-fence.

8. A visual display system according to claim 1, wherein the electronic display comprises a liquid crystal display (LCD) screen, light-emitting diode (LED) screen or a plasma technology screen.

9. A visual display system according to claim 1, wherein the electronic display comprises e-ink or e-paper display technology.

10. A visual display system according to claim 1, wherein the electronic display is integrated within exterior bodywork of the vehicle.

11. A visual display system according to claim 1, wherein the system further comprises a power source that is independent from a main electrical power source of the vehicle.

12. A visual display system according to claim 5, wherein the user input device is a mobile device.

13. A visual display system according to claim 12, wherein the user input device is at least one of a smart phone or tablet.

14. A method of controlling a visual display on a vehicle, the method comprising:
providing an electronic display visible from an exterior of the vehicle, and
configuring the electronic display to have the appearance of the vehicle bodywork.

15. A vehicle, comprising
a visual display system comprising an electronic display visible from the exterior of the vehicle, wherein the electronic display is configurable to have the appearance of the vehicle bodywork; and
a controller which is configured to control an image displayed on the electronic display based on at least one of a time of day and an ambient light level, wherein the controller comprises a time monitor capable of monitoring the time of day, wherein the controller is configured to activate or deactivate the electronic display based on a determination whether the time of day matches a predetermined time of day, wherein the controller comprises an optical sensor capable of detecting ambient light levels, wherein the controller is configured to activate or deactivate the electronic display based on a determination whether the detected level of ambient light matches a predetermined level of ambient light.

16. A visual display system according to claim 15, wherein the electronic display is configurable to activate or deactivate the electronic display based on data received from a user input device.

17. A visual display system according to claim 15, wherein the system further comprises a vehicle locator and the controller is further configured to activate or deactivate the electronic display based on a determination of whether the location of the vehicle matches a predetermined location.

18. A visual display system according to claim 17, wherein the predetermined location is set according to a geo-fence.

19. A visual display system according to claim 15, wherein the electronic display is integrated within exterior bodywork of the vehicle.

20. A visual display system according to claim 15, wherein a power source that is independent from a main electrical power source of the vehicle.
